(19) United States
(12) Patent Application Publication
(10) Pub. No.: US 2021/0270244 A1
(43) Pub. Date: Sep. 2, 2021

(54) METHOD AND SYSTEM FOR FAULT DIAGNOSIS OF GEARBOX OF WIND TURBINE GENERATOR

(71) Applicant: WUHAN UNIVERSITY, HUBEI (CN)

(72) Inventors: Yigang HE, HUBEI (CN); Li LU, HUBEI (CN); Liulu HE, HUBEI (CN); Guolong SHI, HUBEI (CN); Chaolong ZHANG, HUBEI (CN)

(73) Assignee: WUHAN UNIVERSITY, HUBEI (CN)

(21) Appl. No.: 17/123,070

(22) Filed: Dec. 15, 2020

(30) Foreign Application Priority Data
Mar. 2, 2020 (CN) 202010134735.9

(51) Int. Cl. F03D 17/00; G01M 13/021; G01M 13/028

(52) U.S. Cl. CPC F03D 17/00; F05B 2260/80; G01M 13/028; G01M 13/021

(57) ABSTRACT

The invention provides to a method and a system for fault diagnosis of a gearbox of a wind turbine generator based on stacked denoising autoencoders and relates to fault diagnosis. Signals obtained by pre-processing original vibration signals collected when the gearbox of the wind turbine generator is in different working states are used as training data. The training data are input into stacked denoising autoencoders. Meanwhile, a quantum-behaved particle swarm optimization algorithm is introduced to optimize the structure and parameters. Then, pre-processed test signals are input into the stacked denoising autoencoders that are trained to extract high-dimensionality fault features contained in the original vibration signals. Then, the extracted fault features are input into a least squares support vector machine to complete the fault diagnosis of the gearbox.

### CROSS-REFERENCE TO RELATED APPLICATION

This application claims the priority benefit of China application serial no. 202010134735.9, filed on Mar. 2, 2020. The entirety of the above-mentioned patent application is hereby incorporated by reference herein and made a part of this specification.

### BACKGROUND OF THE INVENTION

### Field of the Invention

The invention relates to fault diagnosis, and more particularly relates to a method and a system for fault diagnosis of a gearbox of a wind turbine generator based on stacked denoising autoencoders.

### Description of Related Art

In recent years, tremendous progress has been made in wind power generation. However, compared with conventional power systems such as those using coal, natural gas, etc., the operation and maintenance cost for a wind power system is higher. Therefore, it is necessary to adopt a proactive strategy for the maintenance of a wind power project, and, as a consequence, it is crucial to monitor the state, diagnose, predict, and implement health management to reduce the maintenance cost of a wind turbine. A majority of gearbox faults result from faulted gears. The maintenance required for a gearbox fault is complicated, and the cost for assembling/dissembling, transporting, and maintaining the gearbox is high. Therefore, to ensure normal operation of a wind turbine, further studies on the faults of gearboxes of wind power generators are required.

Chinese patent publication no. CN104792520A discloses a fault diagnosis method for a gearbox of a wind turbine generator system, and proposes a fault diagnosis method for a gearbox of a wind turbine generator system based on local mean decomposition and an optimized K mean value clustering algorithm, in which original vibration signals are decomposed and reconstructed, and an analysis is carried out on the reconstructed signals. Since the working conditions of a gearbox are complicated, decomposing the original signal may result in loss of high-dimensionality features, making it unable to obtain favorable fault diagnosis performance. Chinese patent publication no. CN108256556A discloses a fault diagnosis method for a wind generating set gearbox on the basis of a deep belief network, according to which a waveform database of working conditions of the gearbox is directly constructed, and original signals are input into a trained deep faith network to generate a waveform for comparison with the waveforms of different working conditions in the database. However, such an experience-based deep structure according to this method is unable to optimally extract features, and the efficacy of the fault diagnosis so rendered is significantly affected.

### SUMMARY OF THE INVENTION

In view of the issues in the conventional art, the invention proposes a method and a system for fault diagnosis of a gearbox of a wind turbine generator based on stacked denoising autoencoders capable of facilitating the diagnosis efficacy based on the current diagnosis method.

For the above objectives, an aspect of the invention provides a method for fault diagnosis of a gearbox of a wind turbine generator based on stacked denoising autoencoders. The method includes:

(1) respectively obtaining a plurality of sets of original vibration signals under respective fault conditions, performing a Fourier transformation process and a normalization process on each of the original vibration signals to obtain a spectrum signal corresponding to each of the original vibration signals, and forming training data from all the spectrum signals;

(2) performing unsupervised training on a plurality of denoising autoencoders by using the training data;

(3) stacking together hidden layers of the respective denoising autoencoders that are trained, and adding the hidden layers to a logic regression layer to form the stacked denoising autoencoders; and

(4) optimizing the stacked denoising autoencoders by performing supervised training using a quantum-behaved particle swarm optimization method to obtain optimized stacked denoising autoencoders, so as to perform fault diagnosis by using the optimized stacked denoising autoencoders.

According to an embodiment of the invention, Step (2) includes:

(2.1) obtaining respective mapped signals by performing random mapping to the spectrum signals in the training data;

(2.2) adding non-masking noise to each of the mapped signals to obtain noise-contaminated signals, and mapping each of the noise-contaminated signals to the hidden layer; and

(2.3) obtaining respective reconstruction signals through reconstruction by a decoder in the hidden layer, and obtaining an optimal parameter of the denoising autoencoder through obtaining a minimum value of squared reconstruction errors according to the respective reconstruction signals and the respective spectrum signals.

According to an embodiment of the invention, an optimal parameter {θ_{f}, θ_{g}} of the denoising autoencoder is obtained by obtaining a minimum value of

$$L ( {X}_{2} , {X}_{5} ) = {\sum }_{i = 1}^{n} {‖ {X}_{{2}_{i}} - {X}_{{5}_{i}} ‖}^{2} ,$$

wherein θ_{f} represents a parameter set {W₁, b_{g}}, θ_{g} represents a parameter set {W₂, b₂}, X₂ represents the spectrum signal, X₅ represents the reconstruction signal, and X₅=σ(W₂h+b₂), h represents the hidden layer, h=σ(W₁X₄+b₁), σ is a sigmoid function for realizing non-linear deterministic mapping, W₁ represents a weight after mapping conversion of the hidden layer, b₁ represents an offset after mapping of the hidden layer, X₄ represents the noise-contaminated signal, W₂ represents a weight after reconstruction, b₂ represents an offset for reconstruction, X₂_{ᵢ} represents an i^{th} spectrum signal, X₅_{ᵢ} represents an i^{th} reconstruction signal, and n represents a number of the spectrum signals in the training data.

According to an embodiment of the invention, before Step (4), the method further includes:

initializing parameters of the stacked denoising autoencoders by using optimal parameters of the respective denoising encoders obtained in the unsupervised training, and updating weight values of the stacked denoising autoencoders by using a stochastic gradient descent method.

According to an embodiment of the invention, Step (4) includes:

(4.1) mapping a learning rate and a hidden layer number of the stacked denoising autoencoders as particle positions;

(4.2) obtaining an optimal individual position of each particle and a global optimal position of a swarm according to an adaption value of each particle in the swarm;

(4.3) obtaining a global optimal position of a corresponding particle according to the optimal individual position of each particle, and updating the particle positions according to the global optimal positions of the respective particles;

(4.4) repeating Steps (4.1) to (4.3) until an iteration stop condition is met, and using a swarm global optimal position that is obtained as the learning rate and the hidden layer number of the stacked denoising autoencoder.

According to an embodiment of the invention, an adaption value fitness (Nₕ,lᵣ) of each particle in the swarm is obtained according to fitness

$$( {N}_{h} , {l}_{r} ) = \sqrt{\frac{1}{M} {\sum }_{i = 1}^{M} {( {x}_{i} - {y}_{i} )}^{2}} ,$$

wherein lᵣ represents the learning rate of the stacked denoising autoencoders, Nₕ represents the hidden layer number of the stacked denoising autoencoders, M represents a swarm size, xᵢ represents actual values of the learning rate and the hidden layer number of the stacked denoising autoencoders, and yᵢ represents predicted values of the learning rate and the hidden layer number of the stacked denoising autoencoders.

According to an embodiment of the invention, Step (4.3) includes: updating the particle positions according to

$$\{ \begin{matrix}{m}_{b e s t} = \frac{1}{M} {\sum }_{i = 1}^{M} {P}_{i} \\ {P}_{{c}_{ij}} = φ {P}_{i j} + ( 1 - φ ) {P}_{gj} \\ {x}_{i j} ( t + 1 ) = {P}_{{c}_{ij}} \pm α \vert {m}_{best j} - {x}_{i j} ( t ) \vert ln ( \frac{1}{u} )\end{matrix} ,$$

wherein m_{best} represents global optimal positions of all individuals, m_{best j} represents a center of optimal current positions in a j^{th} dimension, Pᵢ represents an optimal current position of an i^{th} particle, Pᵢⱼ represents an optimal position of the i^{th} particle in the j^{th} dimension, P_{gj} represents an optimal position of a g^{th} particle in the j^{th} dimension, P_{c}_{ᵢⱼ} represents a computable random position between Pᵢⱼ and P_{gj}, φ⊂(0,1) u⊂(0,1), α represents a control coefficient, t represents a number of iterations, xᵢⱼ (t) represents a position of the i^{th} particle in the j^{th} dimension in a t^{th} iteration of the iterations.

According to an embodiment of the invention, performing the fault diagnosis by using the optimized stacked denoising autoencoders includes:

obtaining a target vibration signal of a to-be-diagnosed gearbox of a wind turbine generator, and performing the Fourier transformation process and the normalization process on the target vibration signal to obtain a target spectrum signal;

extracting a fault feature signal by using the stacked denoising autoencoders, and identifying the fault feature signal by using a least squares support vector machine to obtain a fault type.

According to another aspect of the invention, a system for fault diagnosis of a gearbox of a wind turbine generator based on stacked denoising autoencoders is provided. The system includes:

a data processing module, configured to respectively obtain a plurality of sets of original vibration signals under respective fault conditions, perform a Fourier transformation process and a normalization process on each of the original vibration signals to obtain a spectrum signal corresponding to each of the original vibration signals, and form training data from all the spectrum signals;

a first training module, configured to perform unsupervised training on a plurality of denoising autoencoders by using the training data;

a stacked denoising autoencoder constructing module, configured to stack together hidden layers of the respective denoising autoencoders that are trained, and add the hidden layers to a logic regression layer to form stacked denoising autoencoders; and

a second training module, configured to optimize the stacked denoising autoencoders by performing supervised training using a quantum-behaved particle swarm optimization method to obtain optimized stacked denoising autoencoders, so as to perform fault diagnosis by using the optimized stacked denoising autoencoders.

According to yet another aspect of the invention, a computer-readable storage medium is provided. The computer-readable storage medium stores a program command, and when the program command is executed by a processor, the method for the fault diagnosis of the gearbox of the wind turbine generator based on the stacked denoising autoencoders according to the embodiments of the invention is realized.

In general, compared with the conventional art, the technical solution of the invention is capable of constructing the stacked denoising autoencoders by using the collected gearbox fault signals. Since the signals used in the construction process are obtained from the same gearbox, the optimized stacked denoising autoencoders are able to effectively extract the fault features in the signals of the same gearbox. The extracted fault features include high-dimensionality information of the original vibration signals. By inputting the feature signals into the least squares support vector machine, the fault types can be effectively identified. Accordingly, a strong basis is provided for pinning down the location of the fault of the gearbox and maintaining the gearbox. Accordingly, the stability and reliability of the operation of the equipment are ensured.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic flowchart illustrating a method for fault diagnosis of a gearbox based on stacked denoising autoencoders according to an embodiment of the invention.

FIG. 2 is a diagram illustrating a feature extraction efficacy of a kind of stacked denoising autoencoders according to an embodiment of the invention.

FIG. 3 is a diagram illustrating a structure of an individual denoising autoencoder according to an embodiment of the invention.

FIG. 4 is a diagram illustrating a structure of a kind of stacked denoising autoencoders according to an embodiment of the invention.

FIG. 5 is a schematic diagram illustrating a structure of a system according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to make the objectives, technical solutions, and advantages of the invention clearer, the following further describes the invention in detail with reference to the accompanying drawings and embodiments. It should be understood that the specific embodiments described herein only serve to explain the invention, but not to limit the invention. In addition, the technical features involved in the various embodiments of the invention described below may be combined with each other as long as such technical features do not conflict with each other.

In the examples of the invention, terms such as “first”, “second”, etc. are used to distinguish different objects, and do not necessarily imply a specific order or sequence.

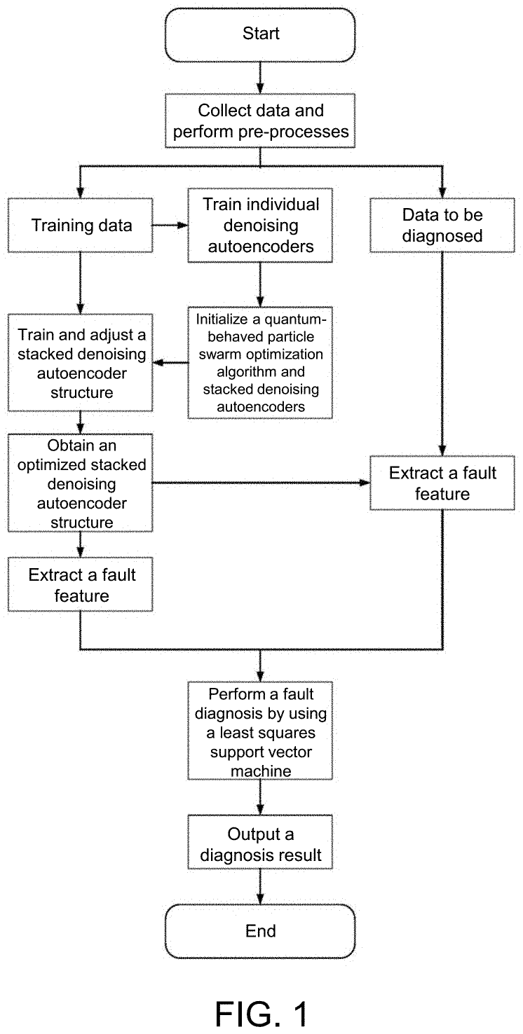

FIG. 1 is a schematic flowchart illustrating a method for fault diagnosis of a gearbox of a wind turbine generator based on stacked denoising autoencoders according to an embodiment of the invention. The method includes steps described in the following.

S1: Collecting, by using an acceleration sensor, original vibration signals X under different fault conditions, performing a Fourier transformation process on the original vibration signals X to obtain spectrum signals X₁, and normalizing the spectrum signals X₁ to obtain normalized spectrum signals X₂: A normalization formula is as follows:

$${x}_{n o r m} = \frac{x - {x}_{min}}{{x}_{max} - {x}_{min}} , \qquad ( 1 )$$

wherein xₙₒᵣₘ represents a normalized value, xₘᵢₙ and xₘₐₓ respectively represent the minimum value and the maximum value in the spectrum signals X₁.

S2: Constructing a stacked denoising autoencoder structure:

As shown in FIG. 3, firstly, unsupervised training is performed on individual denoising autoencoders. In the individual denoising autoencoders, signals X₃ are obtained from the normalized spectrum signals X₂ through random mapping. A mapping formula is as follows:

X₃=q_{D}(X₃|X₂) (2),

wherein D represents an original data set.

Non-masking noise is added to the mapped signals X₃ to obtain noise-contaminated signals X₄. Then, the obtain noise-contaminated signals X₄ are mapped to a hidden layer h represented as follows:

h=f(X₄,θ_{f})=σ(W₁X₄+b₁) (3),

wherein θ_{f} represents a parameter set {W₁,b₁}, W₁ represents a weight matrix for mapping of the hidden layer, b₁ is an offset vector for mapping of the hidden layer, and σ is a sigmoid function for realizing non-linear deterministic mapping, whose formula is represented as follows:

$$σ ( x ) = \frac{1}{1 + {e}^{- x}} . \qquad ( 4 )$$

Then, reconstructed data X₅ is obtained by the hidden layer h through decoder reconstruction. An expression thereof is as follows:

X₅=g(h,θ_{g})=σ(W₂h+b₂) (5),

wherein θ_{g} represents a parameter set {W₂,b₂}, W₂ represents a weight matrix upon reconstruction, b₂ represents an offset vector upon reconstruction, and an optimal parameter set {θ_{f},θ_{g}} is obtained by obtaining the minimum value of squared reconstruction errors. A formula for obtaining the minimum value of the squared reconstruction errors is as follows:

$$L ( {X}_{2} , {X}_{5} ) = {\sum }_{i = 1}^{n} {‖ {X}_{{2}_{i}} - {X}_{{5}_{i}} ‖}^{2} , \qquad ( 6 )$$

wherein n is the number of the normalized spectrum signals X₂.

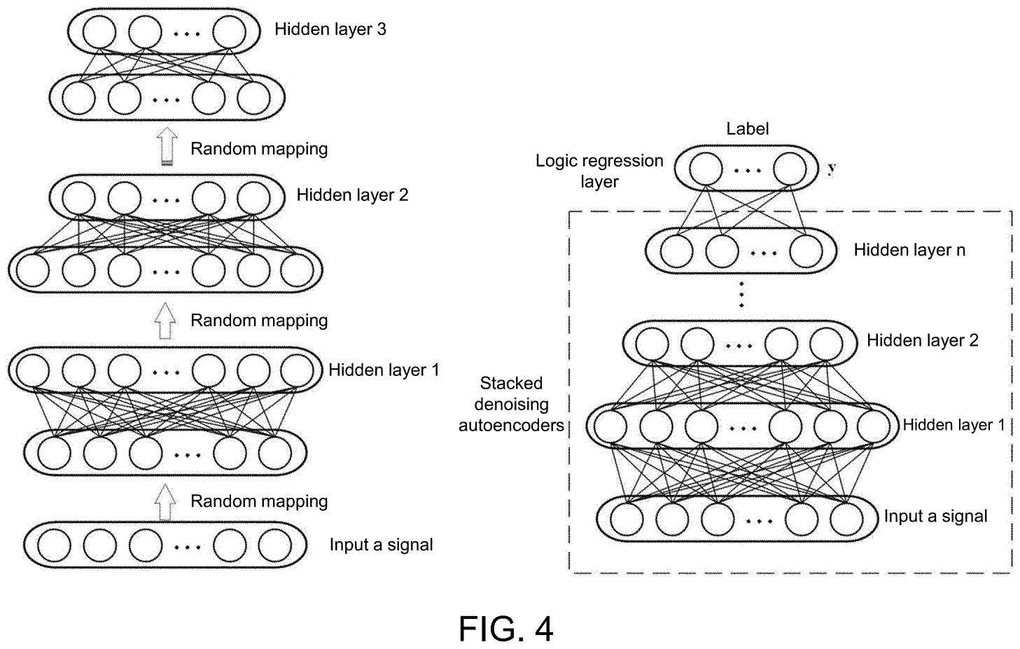

As shown in FIG. 4, after the training of the individual denoising autoencoders is completed, all the hidden layers are stacked together and added to a logic regression layer to form stacked denoising autoencoders.

By using the corresponding parameters obtained during the process of unsupervised training, the parameters of the stacked denoising autoencoders are initialized. Then, a back propagation algorithm is adopted to perform supervised training on annotated information of the parameters, i.e., updating weight values by using a stochastic gradient descent method. The initial stacked denoising autoencoder structure is still unable to render the optimal efficacy in extracting features of gearbox faults. Here, a quantum-behaved particle swarm optimization algorithm is introduced to provide a stacked denoising autoencoder structure with a favorable feature extraction efficacy. Here, the annotated information of the parameters refers to a corresponding parameter set {θ_{f},θ_{g}} corresponding to a corresponding individual denoising autoencoder obtained during the stepwise training process of the individual denoising autoencoder.

An iterative optimization formula for particles in the quantum-behaved particle swarm optimization algorithm is represented as follows:

$$\{ \begin{matrix}{m}_{b e s t} = \frac{1}{M} {\sum }_{i = 1}^{M} {P}_{i} \\ {P}_{{c}_{ij}} = φ {P}_{i j} + ( 1 - φ ) {P}_{gj} \\ {x}_{i j} ( t + 1 ) = {P}_{{c}_{ij}} \pm α \vert {m}_{best j} - {x}_{i j} ( t ) \vert ln ( \frac{1}{u} )\end{matrix} , \qquad ( 7 )$$

wherein m_{best} and m_{best j} respectively represent centers of optimal current positions of all individuals and a j^{th} dimension, Pᵢ is an optimal current position of an i^{th} particle, Pᵢⱼ and P_{gj} are respectively optimal positions of the i^{th} and g^{th} particles in the j^{th} dimension, P_{c}_{ᵢⱼ} represents a computable random position between and P_{gj}, φ⊂(0,1), u⊂(0,1), t represents a number of iterations, xᵢⱼ(t) represents a position of the i^{th} particle in the j^{th} dimension in a t^{th} iteration of the iterations, and α is a control coefficient whose calculation formula is as follows:

α=0.5+0.5×(tₘₐₓ−t)/tₘₐₓ (8),

wherein tₘₐₓ represents a maximum number of iterations, and t represents the number of iterations.

The steps of iterative optimization are as follows:

(1) initializing the quantum-behaved particle swarm optimization algorithm including particle positions, an optimization range, compression/expansion factors, and the number of iterations, wherein a learning rate lᵣ and a hidden layer number Nₕ of the stacked denoising autoencoders to be optimized are mapped as particle positions;

(2) calculating an adaption function of each particle in a swarm to obtain an optimal individual position of each particle and a global optimal position of the swarm, wherein the adaption function formula is represented as follows:

$$fitness ( {N}_{h} , {l}_{r} ) = \sqrt{\frac{1}{M} {\sum }_{i = 1}^{M} {( {x}_{i} - {y}_{i} )}^{2}} , \qquad ( 9 )$$

wherein M represents a swarm size, xᵢ represents actual values of the learning rate and the hidden layer number of the stacked denoising autoencoder, yᵢ represents predicted values of the learning rate and the hidden layer number of the stacked denoising autoencoder obtained from Formula (7), and an optimization objective is to obtain the minimum value of fitness(Nₕ, lᵣ);

(3) calculating an optimal mean of the individual positions of all the particles in the swarm, i.e., a particle global optimal position, and updating the particle positions according to Formula (7);

(4) repeating (1) to (3) of the iterative process for the quantum-behaved particle swarm optimization algorithm until an iteration stop condition is met, wherein output optimization results are the learning rate lᵣ and the hidden layer number Nₕ of the stacked denoising autoencoder.

Thus far, the stacked denoising autoencoder structure determined according to the original gearbox vibration signals under different fault states is obtained. Firstly, the pre-processed gearbox vibration signals are input into a single layer of the denoising autoencoder in the structure for unsupervised training, so as to obtain a denoising autoencoder capable of effectively extracting fault features from gearbox signals. Then, the individual denoising autoencoders are stacked and added to the logic regression layer to form a deep structure. By using the corresponding parameters obtained in the process of unsupervised training, the parameters of the deep structure are initialized, and a process of supervised reverse fine-tuning is performed. Then, the quantum-behaved particle swarm optimization algorithm is introduced to optimize the learning rate and the hidden layer number of the initial stacked denoising autoencoder structure, so as to obtain the stacked denoising autoencoders with a favorable efficacy in extracting the features of the gearbox vibration signals.

Step 3: Performing fault diagnosis on the currently input gearbox vibration signals:

After collecting a plurality of sets of original vibration signals, the sets of original vibration signals are respectively subjected to pre-processes such as Fourier transformation and normalization. The pre-processed signals are input into the optimized stacked denoising autoencoders, and a feature able to specify a fault type thereof is extracted from each signal. Then, the extracted fault features are input into a least squares support vector machine for fault classification. Accordingly, the state of the current signal is diagnosed.

In the embodiment of the invention, a least squares support vector machine using a Gaussian radial basis function as the core function may be adopted. The core function is represented as follows:

$$K ( {x}_{j} , {x}_{j} ) = exp ( - \frac{{‖ {x}_{i} - {x}_{j} ‖}^{2}}{{σ}^{2}} ) , \qquad ( 10 )$$

wherein σ represents a core parameter, and xᵢ and xⱼ respectively represent an i^{th} sampling value and a j^{th} sampling value. The least squares support vector machine is represented as follows:

$$f ( x ) = sgn ( {\sum }_{i = 1}^{l} {α}_{i} {y}_{i} K ( x , {x}_{i} ) + β ) , \qquad ( 11 )$$

wherein αᵢ represents a Lagrange multiplier, yᵢ represents −1 or 1 of a class, β represents a compensating parameter, and l represents a sampling number.

Compared with the conventional art, the embodiment of the invention constructs the stacked denoising autoencoders by using the collected gearbox fault signals. Since the signals used in the construction process are from the same gearbox, the optimized stacked denoising autoencoders are able to effectively extract the fault features in the signals of the same gearbox. The extracted fault features include high-dimensionality information of the original vibration signals. By inputting the feature signals into the least squares support vector machine, the fault types can be effectively identified. Accordingly, a strong basis is provided for pinning down the location of the fault of the gearbox and maintaining the gearbox. Thus, the stability and reliability of the operation of the equipment are ensured.

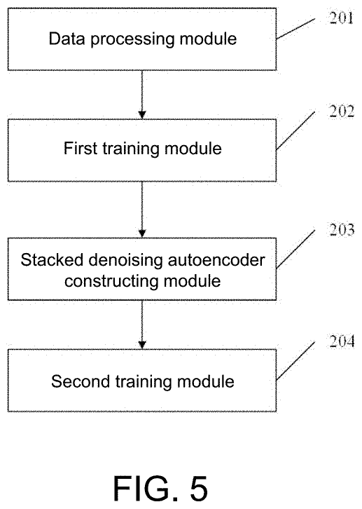

FIG. 5 is a schematic diagram illustrating a structure of a system according to an embodiment of the invention. The structure includes the following:

a data processing module 201, configured to respectively obtain a plurality of sets of original vibration signals under respective fault conditions, perform a Fourier transformation process and a normalization process on each of the original vibration signals to obtain a spectrum signal corresponding to each of the original vibration signals, and form training data from the spectrum signals;

a first training module 202, configured to perform unsupervised training on a plurality of denoising autoencoders by using the training data;

a stacked denoising autoencoder constructing module 203, configured to stack together hidden layers of the respective denoising autoencoders that are trained, and add the hidden layers to a logic regression layer to form stacked denoising autoencoders; and

a second training module 204, configured to optimize the stacked denoising autoencoders by performing supervised training using a quantum-behaved particle swarm optimization method to obtain optimized stacked denoising autoencoders, so as to perform fault diagnosis by using the optimized stacked denoising autoencoders.

Regarding the details of the respective modules, reference is made to the above descriptions made for the embodiment of the method, and the same details will not be repeated in the following for the embodiment of the invention.

In another embodiment of the invention, a computer-readable storage medium is provided. The computer-readable storage medium stores a program command. By executing the program command by a processor, the method for fault diagnosis of the gearbox of the wind turbine generator based on the stacked denoising autoencoders according to the embodiment is realized.

Analysis on Experimental Results

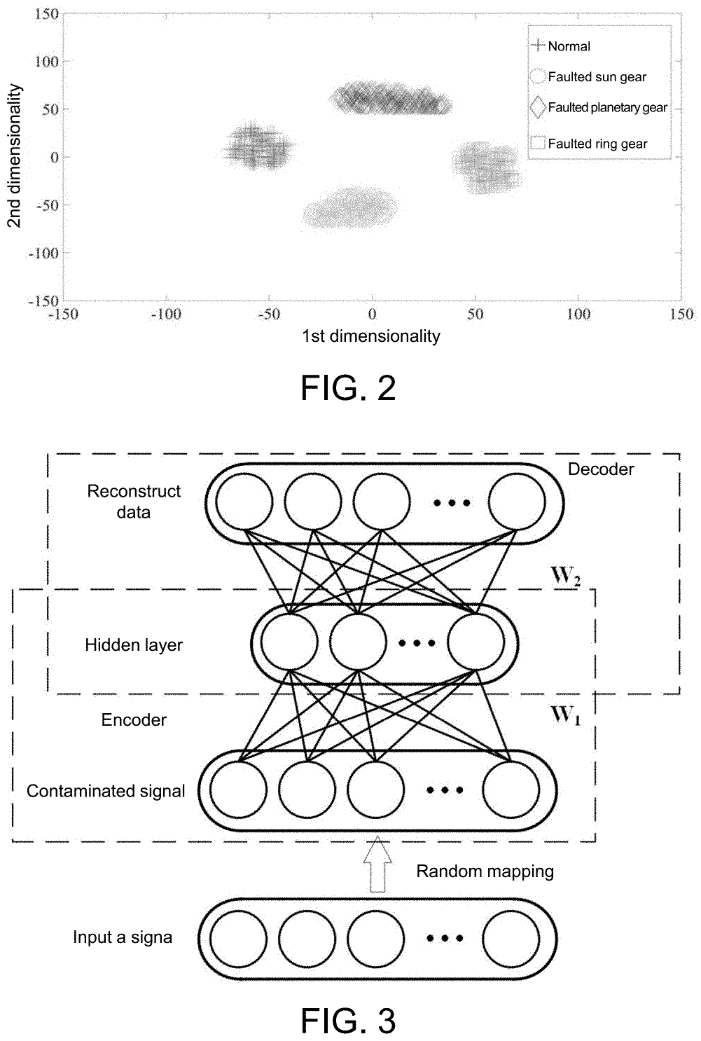

Owing to the limitations of objective conditions, it is difficult to collect a large amount of fault data for research within a short period of time. Therefore, the wind turbine generator gearbox fault data adopted in the embodiment is provided by a motor-driven planetary gearbox fault simulation system. The system includes a motor, a parallel shaft gearbox, a planetary gear, a low-speed bearing, a high-speed bearing, and a magnetic brake, and is capable of simulating various different gearbox fault conditions. As shown in FIG. 2, the gearbox fault simulation system simulated four working conditions (i.e., normal, faulted sun gear, faulted planetary gear, faulted ring gear), and data of the signals of the four known types were collected. The sampling frequency was set at 8000 Hz, and 50 sets of data were collected for each fault type, and 20 sets of the data were adopted as training data, whereas the remaining 30 sets were used as test data.

After performing the Fourier transformation process on 80 sets of training data, the normalization process was performed on the data according to Formula (1). Then, the processed training data were input into the individual denoising autoencoders to perform the unsupervised training according to Formulae (2) to (6). The initial stacked denoising autoencoders were formed through stacking, and the quantum-behaved particle swarm optimization algorithm was initialized. The stacked denoising autoencoders were optimized through supervised training according to Formulae (7) to (9), and a t-SNE non-linear dimensionality reduction algorithm was adopted to reduce the dimensionality of the extracted high-dimensionality features to two, so as to validate the feature extraction efficacy of the stacked denoising autoencoders. The result of a single trial of feature extraction is as shown in FIG. 2.

After the stacked denoising autoencoders were optimized, 120 sets of test data were subjected to the Fourier transformation process and the normalization process. Then, the processed data were input into the stacked denoising autoencoders to extract fault features. Then, the fault feature signals were input into the least squares support vector machine for fault type identification, so as to obtain the percentage of the correctly diagnosed samples with respect to the total samples. Accordingly, the diagnosis accuracy according to the method of the invention was obtained. The diagnosis result is as shown in Table 1.

TABLE 1
Fault Diagnosis Results under Different
Working Conditions of Gearbox

| | Number of | Number of | Number of | |
|---|---|---|---|---|
| | test | correct | incorrect | |
| Gearbox state | samples | classifications | classifications | Accuracy |
| Normal | 30 | 30 | 0 | 100% |
| Faulted sun | 30 | 29 | 1 | 96.67% |
| gear | | | | |
| Faulted | 30 | 29 | 1 | 96.67% |
| planetary gear | | | | |
| Faulted ring | 30 | 28 | 2 | 93.33% |
| gear | | | | |
| Total | 120 | 116 | 4 | 96.67% |

According to Table 1, among the four different working conditions of the gear box, the lowest diagnosis accuracy was as high as 93.33%, and the mean diagnosis accuracy was as high as 96.67%. The results suggest the method for fault diagnosis of the gearbox of the wind turbine generator based on the stacked denoising autoencoders proposed in the invention renders a favorable diagnosis efficacy, and provides a different line of thinking as well as a novel approach for the fault diagnosis of gearboxes of wind power generators.

It is noted that, based on practical needs, the respective steps/parts in the invention may be further divided into more steps/parts, or two more steps/parts or portions of the steps/parts may be combined to form new steps/parts to realize the objectives of the invention.

The method according to the invention may be implemented in hardware or firmware, or realized as software or computer codes in a recording medium (e.g., CD ROM, RAM, soft disk, hard disk, or magneto-optical disc), or computer codes originally stored in a remote recording medium or non-transitory machine-readable medium and downloadable via a network to be stored in a local recording medium and processed by software stored in a recording medium of a general-purpose computer, a dedicated processor, or a programmable or dedicated hardware component (e.g., ASIC or FPGA). It is understood that a computer, a processor, a microprocessor controller, or a programmable hardware component include a storage component (e.g., RAM, ROM, flash memory, etc.) capable of storing or receiving software or computer codes. When the software or computer codes are accessed and executed by a computer, a processor, or a hardware component, the processing method described herein is realized. In addition, when a general-purpose computer accesses the codes for realizing the processes described herein, by executing the codes, the general-purpose computer is turned into a dedicated computer for executing the processes described herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fault diagnosis of a gearbox of a wind turbine generator based on stacked denoising autoencoders, the method comprising:
step 1, respectively obtaining a plurality of sets of original vibration signals under respective fault conditions, performing a Fourier transformation process and a normalization process on each of the original vibration signals to obtain a spectrum signal corresponding to each of the original vibration signals, and forming training data from all the spectrum signals;
step 2, performing unsupervised training on a plurality of denoising autoencoders by using the training data;
step 3, stacking together hidden layers of the respective denoising autoencoders that are trained, and adding the hidden layers to a logic regression layer to form the stacked denoising autoencoders; and
step 4, optimizing the stacked denoising autoencoders by performing supervised training using a quantum-behaved particle swarm optimization method to obtain optimized stacked denoising autoencoders, so as to perform fault diagnosis by using the optimized stacked denoising autoencoders.

2. The method as claimed in claim 1, wherein step 2 comprises:
step 2.1, obtaining respective mapped signals by performing random mapping to the spectrum signals in the training data;
step 2.2, adding non-masking noise to each of the mapped signals to obtain noise-contaminated signals, and mapping each of the noise-contaminated signals to the hidden layer; and
step 2.3, obtaining respective reconstruction signals through reconstruction by a decoder in the hidden layer, and obtaining an optimal parameter of the denoising autoencoder through obtaining a minimum value of squared reconstruction errors according to the respective reconstruction signals and the respective spectrum signals.

3. The method as claimed in claim 2, wherein an optimal parameter {θ_{f},θ_{g}} of the denoising autoencoder is obtained by obtaining a minimum value of
$$L ( {X}_{2} , {X}_{5} ) = {\sum }_{i = 1}^{n} {‖ {X}_{{2}_{i}} - {X}_{{5}_{i}} ‖}^{2} ,$$
wherein θ_{f}, represents a parameter set {W₁,b₁}, θ_{g} represents a parameter set {W₂,b₂} X₂ represents the spectrum signal, X₅ represents the reconstruction signal, and X₅=σ(W₂h+b₂), h represents the hidden layer, h=σ(W₁X₄+b₁), σ is a sigmoid function for realizing non-linear deterministic mapping, represents a weight upon mapping of the hidden layer, b₁ represents an offset upon mapping of the hidden layer, X₄ represents the noise-contaminated signal, W₂ represents a weight upon reconstruction, b₂ represents an offset upon reconstruction, X₂_{ᵢ} represents an i^{th} spectrum signal, X₅_{ᵢ} represents an i^{th} reconstruction signal, and n represents a number of the spectrum signals in the training data.

4. The method as claimed in claim 1, wherein before step 4, the method further comprises:
initializing parameters of the stacked denoising autoencoders by using optimal parameters of the respective denoising encoders obtained in the unsupervised training, and updating weight values of the stacked denoising autoencoders by using a stochastic gradient descent method.

5. The method as claimed in claim 2, wherein before step 4, the method further comprises:
initializing parameters of the stacked denoising autoencoders by using optimal parameters of the respective denoising encoders obtained in the unsupervised training, and updating weight values of the stacked denoising autoencoders by using a stochastic gradient descent method.

6. The method as claimed in claim 3, wherein before step 4, the method further comprises:
initializing parameters of the stacked denoising autoencoders by using optimal parameters of the respective denoising encoders obtained in the unsupervised training, and updating weight values of the stacked denoising autoencoders by using a stochastic gradient descent method.

7. The method as claimed in claim 4, wherein step 4 comprises:
step 4.1, mapping a learning rate and a hidden layer number of the stacked denoising autoencoders as particle positions;
step 4.2, obtaining an optimal individual position of each particle and a global optimal position of a swarm according to an adaption value of each particle in the swarm;
step 4.3, obtaining a global optimal position of a corresponding particle according to the optimal individual position of each particle, and updating the particle positions according to the global optimal positions of the respective particles;
step 4.4, repeating steps 4.1 to 4.3 until an iteration stop condition is met, and using a swarm global optimal position that is obtained as the learning rate and the hidden layer number of the stacked denoising autoencoder.

8. The method as claimed in claim 7, wherein an adaption value fitness (Nₕ,lᵣ) of each particle in the swarm is obtained according to fitness
$$( {N}_{h} , {l}_{r} ) = \sqrt{\frac{1}{M} {\sum }_{i = 1}^{M} {( {x}_{i} - {y}_{i} )}^{2}} ,$$
wherein lᵣ represents the learning rate of the stacked denoising autoencoders, Nₕ represents the hidden layer number of the stacked denoising autoencoders, M represents a swarm size, xᵢ represents actual values of the learning rate and the hidden layer number of the stacked denoising autoencoders, and yᵢ represents predicted values of the learning rate and the hidden layer number of the stacked denoising autoencoders.

9. The method as claimed in claim 7, wherein step 4.3 comprises: updating the particle positions according to
$$\{ \begin{matrix}{m}_{b e s t} = \frac{1}{M} {\sum }_{i = 1}^{M} {P}_{i} \\ {P}_{{c}_{ij}} = φ {P}_{i j} + ( 1 - φ ) {P}_{gj} \\ {x}_{i j} ( t + 1 ) = {P}_{{c}_{ij}} \pm α \vert {m}_{best j} - {x}_{i j} ( t ) \vert ln ( \frac{1}{u} )\end{matrix} ,$$
wherein m_{best} represents global optimal positions of all individuals, m_{best j} represents a center of optimal current positions in a j^{th} dimension, Pᵢ represents an optimal current position of an i^{th} particle, Pᵢⱼ represents an optimal position of the i^{th} particle in the j^{th} dimension, P_{gj} represents an optimal position of a g^{th} particle in the j^{th} dimension, P_{c}_{ᵢⱼ} represents a computable random position between and Pᵢⱼ and P_{gj}, φ⊂(0,1), u⊂(0,1), α represents a control coefficient, t represents a number of iterations, xᵢⱼ (t) represents a position of the i^{th} particle in the j^{th} dimension in an t^{th} iteration of the iterations.

10. The method as claimed in claim 1, wherein performing the fault diagnosis by using the optimized stacked denoising autoencoders comprises:
obtaining a target vibration signal of a to-be-diagnosed gearbox of a wind turbine generator, and performing the Fourier transformation process and the normalization process on the target vibration signal to obtain a target spectrum signal;
extracting a fault feature signal by using the stacked denoising autoencoders, and identifying the fault feature signal by using a least squares support vector machine to obtain a fault type.

11. A system for fault diagnosis of a gearbox of a wind turbine generator based on stacked denoising autoencoders, the system comprising:
a data processing module, configured to respectively obtain a plurality of sets of original vibration signals under respective fault conditions, perform a Fourier transformation process and a normalization process on each of the original vibration signals to obtain a spectrum signal corresponding to each of the original vibration signals, and form training data from all the spectrum signals;
a first training module, configured to perform unsupervised training on a plurality of denoising autoencoders by using the training data;
a stacked denoising autoencoder constructing module, configured to stack together hidden layers of the respective denoising autoencoders that are trained, and add the hidden layers to a logic regression layer to form stacked denoising autoencoders; and
a second training module, configured to optimize the stacked denoising autoencoders by performing supervised training using a quantum-behaved particle swarm optimization method to obtain optimized stacked denoising autoencoders, so as to perform fault diagnosis by using the optimized stacked denoising autoencoders.

12. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 1 is realized.

13. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 2 is realized.

14. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 3 is realized.

15. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 4 is realized.

16. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 5 is realized.

17. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 6 is realized.

18. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 7 is realized.

19. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 8 is realized.

20. A computer-readable storage medium, wherein the computer-readable storage medium stores a program command, and when the program command is executed by a processor, the method for the fault diagnosis of the gearbox of the wind turbine generator based on the stacked denoising autoencoders as claimed in claim 9 is realized.
